(19) United States
(12) Patent Application Publication
(10) Pub. No.: US 2016/0263607 A1
(43) Pub. Date: Sep. 15, 2016

(54) MASK PLATE AND PREPARATION METHOD THEREOF

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Shaozhuan WANG, Beijing (CN); Shenchun CHANG, Beijing (CN); Guofeng WENG, Beijing (CN)

(21) Appl. No.: 14/744,442

(22) Filed: Jun. 19, 2015

(30) Foreign Application Priority Data
Mar. 13, 2015 (CN) 201510111888.0

(51) Int. Cl. B05B 15/04; B23K 26/362; C23F 1/00

(52) U.S. Cl. CPC B05B 15/045; C23F 1/00; B23K 26/362

(57) ABSTRACT

The present invention discloses a mask plate and a preparation method thereof. The mask plate comprises a graphic region and a blank region arranged in the periphery of the graphic region, wherein vaporization coating holes are formed in the graphic region, and at least one buffer hole is formed in the blank region.

### FIELD OF THE INVENTION

The present invention relates to the field of display technology, in particular to a mask plate and a preparation method thereof.

### BACKGROUND OF THE INVENTION

In the prior art, during the preparation of a mask plate, vaporization coating holes are firstly formed in the mask plate, and then the mask plate, on which the vaporization coating holes are formed, is welded onto a mask plate framework by a stretcher. To avoid sagging deformation of the mask plate due to gravity, a high tensile stress needs to be applied to the mask plate during the stretching process. As a result, the vaporization coating holes formed on the mask plate deform due to the tensile stress. Consequently, the vaporization coating holes deviate from the originally designed dimension and shape, resulting in shape error and dimension error.

As the manufacturing process of display panels has high requirements on the precision of the vaporization coating holes, such errors will have a negative impact on the effect of vaporization coating and degrade the effect of vaporization coating, resulting in great defects in the manufactured display panels.

### SUMMARY OF THE INVENTION

To solve the above problems, the present invention provides a mask plate and a preparation method thereof, in order to solve the problem of mask plate deforming caused by tensile stress.

One aspect of the present invention provides a mask plate including a graphic region and a blank region, wherein the blank region is arranged in the periphery of the graphic region, vaporization coating holes are formed in the graphic region, and at least one buffer hole is formed in the blank region.

According to embodiments of the present invention, the vaporization coating holes may be arranged in at least one line in the horizontal direction, and at least one buffer hole is arranged on each side, in the horizontal direction, of each line of vaporization coating holes, respectively.

According to embodiments of the present invention, the buffer hole may be formed in at least one shape selected from rectangle, ellipse, circle and semicircle, and the eccentricity of an ellipse may be ranging from 0.2 to 0.8 when the buffer hole is formed in an elliptic shape.

According to embodiments of the present invention, the buffer hole may be formed to be a through hole or a blind hole, and when the buffer hole is formed to be a blind hole, the ratio of the depth of the blind hole to the thickness of the mask plate may be ranging from 20% to 80%.

According to embodiments of the present invention, the width of the buffer hole may be the same as that of the vaporization coating hole.

According to embodiments of the present invention, the distance between the buffer hole and the edge of the graphic region may be greater than or equal to 1 mm, and the distance between the buffer hole and the edge of the mask plate may be greater than or equal to 1 mm.

Another aspect of the present invention provides a method for preparing a mask plate including: forming vaporization coating holes in a graphic region of a mask plate, and forming at least one buffer hole in a blank region which is arranged in the periphery of the graphic region of the mask plate.

According to embodiments of the present invention, the vaporization coating holes may be arranged in at least one line in the horizontal direction, and at least one buffer hole is arranged on each side, in the horizontal direction, of each line of vaporization coating holes, respectively.

According to embodiments of the present invention, the vaporization coating holes and the buffer hole may be formed by a chemical etching process or a laser etching process.

According to embodiments of the present invention, the material of a mask plate may comprise invar.

The present invention has the following beneficial effects:

According to the mask plate provided by the present invention, the solutions thereof can eliminate or reduce the tensile deformation of the mask plate caused by tensile stress, so as to improve the effect of vaporization coating, and consequently ensure the accuracy of the subsequent vaporization coating process.

### BRIEF DESCRIPTION OF THE DRAWINGS

FIG. 1 is a structural diagram of a mask plate according to one embodiment of the present invention;

FIG. 2 is a structural diagram of a mask plate according to another embodiment of the present invention; and

FIG. 3 is a flowchart of a method for preparing a mask plate according to embodiments of the present invention.

### DETAILED DESCRIPTION OF THE EMBODIMENTS

To make those skilled in the art understand the technical solutions of the present invention better, a mask plate and a preparation method thereof provided by the present invention will be further described below in details with reference to the accompanying drawings.

Organic material is required to be vaporizing coated onto the surface of a glass substrate when a display panel is manufactured, and a mask plate is required during the vaporization coating of the organic material to obtain a required pattern on the glass substrate.

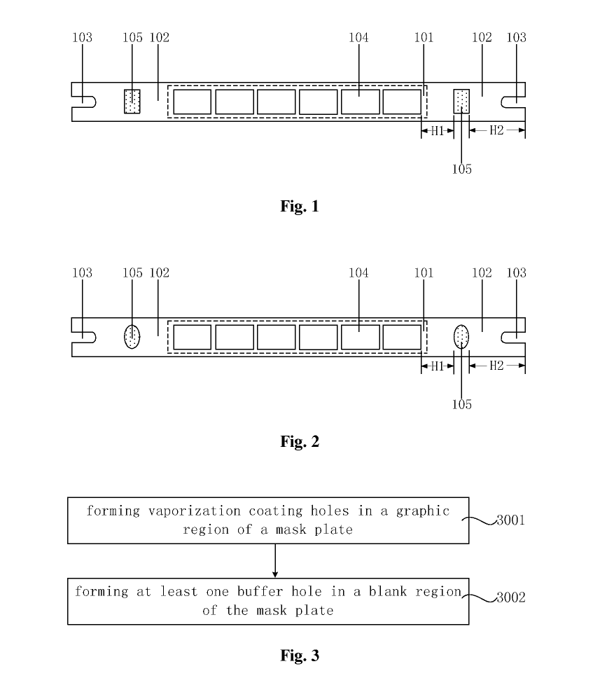

FIG. 1 is a structural diagram of a mask plate according to one embodiment of the present invention.

As shown in FIG. 1, a mask plate comprises a graphic region 101 and a blank region 102, wherein the blank region 102 is arranged in the periphery of the graphic region 101, so that the blank region 102 surrounds the graphic region 101.

According to the embodiment, the mask plate is a strip-shaped mask plate, thus the blank region 102 may be arranged at both ends of the strip-shaped mask plate. In addition, a U-shaped fixing slot 103 may be further arranged at both ends of the strip-shaped mask plate and used for fixing the strip-shaped mask plate to a mask plate framework.

According to the embodiment, vaporization coating holes 104 are formed in the graphic region 101, and buffer holes 105 are formed in the blank region 102. The tensile stress applied to the mask plate may be redistributed through the buffer holes 105, in order to avoid, to the maximum extent, the deformation of the mask plate effecting on the location and shape of the vaporization coating holes 104.

Tests have shown that, under a tensile stress of about 100 N, with the same arrangement of vaporization coating holes, the average deformation of common mask plates in a size of 1865 mm*100 mm*0.1 mm is 25 μm, but the amount of deformation of the mask plate of this embodiment is less than 11.6 μm. Therefore, the mask plate according to the embodiment may reduce the tensile deformation greatly, consequently ensuring the accuracy of the subsequent vaporization coating process.

According to embodiments of the present invention, the material of the mask plate may be invar. Specifically, invar may be ferronickel, wherein the content of nickel takes up 35.4% of ferronickel by weight percentage. Invar, due to its small expansion coefficient, low thermal conductivity, high plasticity and high toughness and the like, can improve the effect of vaporization coating.

In an embodiment as shown in FIG. 1, the vaporization coating holes are arranged in at least one line in the horizontal direction, and at least one buffer hole 105 is arranged on each side, in the horizontal direction, of each line of vaporization coating holes. As shown in FIG. 1, both the vaporization coating holes 104 and the buffer hole 105 are rectangular, and the edge of the buffer hole 105 in the longitudinal direction is arranged in the same height as that of the rectangular vaporization coating holes 104, so that the buffer hole 105 can disperse the tensile stress, in order to eliminate or reduce the tensile deformation of the mask plate caused by the tensile stress, thus ensuring the accuracy of the subsequent vaporization coating process. It should be realized that terms like “in the horizontal direction”, “in the longitudinal direction” and “height” herein are used to describe the embodiment shown in the drawings clearer, and are related to the direction shown in the drawings. When a drawing is rotated by 90° (or any other degrees), correspondently, the above terms, related to direction, should be explained accordingly.

To disperse the tensile stress more uniformly, the buffer hole 105 may be formed to be a through hole or a blind hole. When the buffer hole 105 is formed to be a blind hole, the ratio of the depth of the blind hole to the thickness of the mask plate may be ranging from 20% to 80%, so that the tensile stress acting on the vaporization coating holes 104 is as small as possible to keep the shape and size of the vaporization coating holes 104 unchanged.

According to embodiments of the present invention, the width of the buffer hole 105 may be the same as that of the vaporization coating holes 104, and the distance H1 between the buffer hole 105 and the edge of the graphic region 101 may be greater than or equal to 1 mm, and the distance H2 between the buffer hole 105 and the edge of the mask plate may be greater than or equal to 1 mm, so that the tensile stress may be dispersed more uniformly.

FIG. 2 is a structural diagram of a mask plate according to another embodiment of the present invention. The another embodiment differs from the embodiment shown in FIG. 1 in that, in the embodiment shown in FIG. 2, the buffer hole 105 is formed to be an ellipse.

With reference to FIG. 2, the vaporization coating holes 104 are rectangular and the buffer holes 105 are elliptic, and the eccentricity of the ellipse may be ranging from 0.2 to 0.8.

In addition to the shown shapes, the buffer hole 105 may be further formed in a circular shape, a semicircular shape or other shapes.

FIG. 3 is a flowchart of a method for preparing a mask plate according to embodiments of the present invention.

As shown in FIG. 3, the preparation method may include:

Step 3001: forming vaporization coating holes in a graphic region of a mask plate; and

Step 3002: forming at least one buffer hole in a blank region which is arranged in the periphery of the graphic region of the mask plate.

According to the embodiments of the present invention, after step 3001, the mask plate on which vaporization coating holes are formed is pre-heated at a temperature of 110° C., and is then uniformly coated with photoresist. By an exposure process, a desired buffer hole pattern is formed in the blank region of the mask plate, and then the mask plate is annealed at a temperature of 135° C. In step 3002, the mask plate may be developed with an NaOH solution, and then the buffer hole is formed by an etching process. The mask plate may be etched with a weak acidic solution.

Multiple buffer holes may constitute a buffer zone in the periphery of the vaporization coating holes, so that the tensile stress may be dispersed uniformly to avoid errors of the vaporization coating holes due to their deformation. This improves the effect of vaporization coating, and consequently ensures the accuracy of the subsequent vaporization coating process.

According to the embodiments of the present invention, the vaporization coating holes and the buffer holes may be formed by a chemical etching process or a laser etching process. This is because both the chemical etching process and the laser etching process require no complicated clamping operation, thereby avoiding damage to the mask plate. In addition, forming the vaporization coating holes and buffer holes by a chemical etching process and laser etching process not only meets the requirements of the actual process, but also ensures high accuracy, so that the requirement on the accuracy of the vaporization coating process is satisfied.

It may be understood that, the above implementations are exemplary implementations merely used to describe the principle of the present invention, and the present invention is not limited thereto. For a person of ordinary skill in the art, various variations and improvements may be made without departing from the spirit and essence of the present invention, and those variations and improvements should also be regarded as falling into the protection scope of the present invention.

1. A mask plate, comprising a graphic region and a blank region, wherein the blank region is arranged in the periphery of the graphic region, vaporization coating holes are formed in the graphic region, and at least one buffer hole is formed in the blank region.

2. The mask plate according to claim 1, wherein, the vaporization coating holes are arranged in at least one line in the horizontal direction, and at least one buffer hole is arranged on each side, in the horizontal direction, of each line of vaporization coating holes, respectively.

3. The mask plate according to claim 1, wherein, the buffer hole is formed in at least one shape selected from rectangle, ellipse, circle and semicircle.

4. The mask plate according to claim 3, wherein, the eccentricity of an ellipse is ranging from 0.2 to 0.8 when the buffer hole is formed in an elliptic shape.

5. The mask plate according to claim 1, wherein, the buffer hole is formed to be a through hole or a blind hole.

6. The mask plate according to claim 5, wherein, when the buffer hole is formed to be a blind hole, the ratio of the depth of the blind hole to the thickness of the mask plate is ranging from 20% to 80%.

7. The mask plate according to claim 1, wherein, the width of the buffer hole is the same as that of the vaporization coating hole.

8. The mask plate according to claim 1, wherein, the distance between the buffer hole and the edge of the graphic region is greater than or equal to 1 mm, and the distance between the buffer hole and the edge of the mask plate is greater than or equal to 1 mm.

9. A method for preparing a mask plate, comprising:
forming vaporization coating holes in a graphic region of a mask plate; and
forming at least one buffer hole in a blank region which is arranged in the periphery of the graphic region of the mask plate.

10. The method for preparing a mask plate according to claim 9, wherein the vaporization coating holes are arranged in at least one line in the horizontal direction, and at least one buffer hole is arranged on each side, in the horizontal direction, of each line of vaporization coating holes, respectively.

11. The method for preparing a mask plate according to claim 9, wherein the vaporization coating holes and the buffer hole are formed by a chemical etching process or a laser etching process.

12. The method for preparing a mask plate according to claim 9, wherein the material of a mask plate comprises invar.
